(19) United States
(12) Patent Application Publication
(10) Pub. No.: US 2021/0134477 A1
(43) Pub. Date: May 6, 2021

(54) RESIN COMPOSITION AND MOLDED ARTICLE

(71) Applicant: CANON KABUSHIKI KAISHA, Tokyo (JP)

(72) Inventor: Takahiro Kojima, Kanagawa (JP)

(21) Appl. No.: 17/078,314

(22) Filed: Oct. 23, 2020

(30) Foreign Application Priority Data
Oct. 31, 2019 (JP) 2019-199319

(51) Int. Cl. H01B 1/24; C08K 3/04; C08K 5/25; C08K 13/02; C08L 29/14; C08J 5/12

(52) U.S. Cl. CPC H01B 1/24; C08K 3/04; C08K 5/25; C08K 13/02; C08J 2463/04; C08J 5/12; C08K 2201/001; C08J 2329/14; C08L 29/14

(57) ABSTRACT

Provided is a resin composition including: a polyacetal; conductive carbon black; graphite; and a specific polyacetal decomposition inhibitor, wherein the conductive carbon black has a dibutyl phthalate oil absorption of 180 ml/100 g or less, wherein the content of the polyacetal in the resin composition is 60 mass % or more, and wherein the content of the conductive carbon black in the resin composition is 16 mass % or more and 20 mass % or less.

### BACKGROUND OF THE INVENTION

### Field of the Invention

The present disclosure relates to a resin composition and a molded article each including a polyacetal.

### Description of the Related Art

A polyacetal (hereinafter sometimes referred to as “POM”) is a resin having balanced mechanical properties and excellent slidability. In particular, the resin is excellent in slidability, and hence has been widely used in, for example, various precision mechanism parts typified by a gear and OA equipment.

In particular, in recent years, the integration of members has been required in various applications, and hence a conductive POM resin composition obtained by imparting, as a characteristic except the slidability, conductivity to the POM has been applied to a member having performance by which static electricity generated at the time of its sliding is removed and a function as a conductive wiring.

To deal with those applications, the conductive POM resin composition has started to be required to have excellent dimensional stability in addition to stable conductive performance.

In International Publication No. WO2013/108834, there is a disclosure of a conductive POM resin composition obtained by blending a POM with conductive carbon black having a dibutyl phthalate oil absorption of 180 ml/100 g or less, the composition being excellent in dimensional accuracy (molding shrinkage) and capable of maintaining a conductivity level even at the time of long-term sliding.

In addition, in Japanese Patent Application Laid-Open No. 2009-269996, there is a disclosure of a POM resin composition obtained by blending a POM with conductive carbon black having a dibutyl phthalate oil absorption of 350 ml/100 g or more and graphite, the composition having stable and high conductivity at the time of bearing sliding.

It has been difficult to provide a resin composition having a low thermal expansion rate and intended for injection molding applications, which has high conductivity and provides sufficient dimensional stability against a temperature change, and a resin molded body molded out of the composition.

### SUMMARY OF THE INVENTION

A resin composition of the present disclosure is a resin composition including: a polyacetal; conductive carbon black; graphite; and at least one selected from the group consisting of a compound represented by the formula (1) and a compound represented by the formula (2), wherein the conductive carbon black has a dibutyl phthalate oil absorption of 180 ml/100 g or less, wherein a content of the polyacetal in the resin composition is 60 mass % or more, and wherein a content of the conductive carbon black is 16 mass % or more and 20 mass % or less with respect to the resin composition:

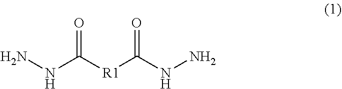

in the formula (1), R1 represents a structure represented by the formula (1-1) or a structure represented by the formula (1-2);

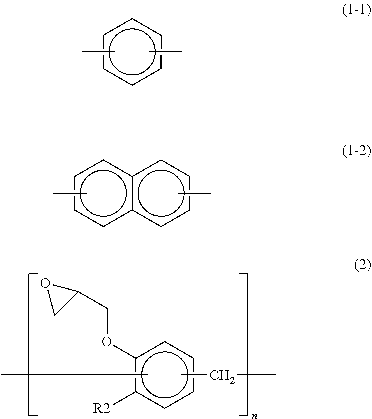

in the formula (2), R2 represents a hydrogen atom or a methyl group, and “n” represents an integer, and when “n” represents 2 or more, R2s may be identical to or different from each other.

In addition, a resin molded body of the present disclosure is a resin molded body including: a polyacetal; conductive carbon black; graphite; and at least one selected from the group consisting of a compound represented by the formula (1) and a compound represented by the formula (2), wherein the conductive carbon black has a dibutyl phthalate oil absorption of 180 ml/100 g or less, wherein a content of the polyacetal in the resin molded body is 60 mass % or more, and wherein a content of the conductive carbon black in the resin molded body is 16 mass % or more and 20 mass % or less.

Further features of the present disclosure will become apparent from the following description of exemplary embodiments.

### DESCRIPTION OF THE EMBODIMENTS

The dibutyl phthalate oil absorption of conductive carbon black is affected by a connection (structure) between carbon particles, and in general, carbon having a larger oil absorption tends to provide a resin composition having higher conductivity even when its blending amount is small.

Accordingly, the conductive POM resin composition disclosed in International Publication No. WO2013/108834, which is blended with the carbon black having a dibutyl phthalate oil absorption of 180 mL/100 g or less, has a volume resistivity of more than 10 Ω·cm, and hence there is a problem in that the upper limit of the resistivity is liable to be high in order that the composition may be stably used as a conductive wiring.

Meanwhile, in each of Comparative Examples described in International Publication No. WO2013/108834 and Japanese Patent Application Laid-Open No. 2009-269996, an extremely high conductivity level is achieved by using the conductive carbon black having a dibutyl phthalate oil absorption of 350 ml/100 g or more while reducing the blending amount of the conductive agent. However, there occurs a problem in that the thermal expansion of the conductive POM resin composition is liable to be large because the blending amount of the conductive agent that also serves as an inorganic filler is small.

The linear expansion coefficient of the polyacetal is from about 110 ppm/° C. to about 120 ppm/° C., and is hence liable to be a value larger than that of an amorphous plastic, such as an acrylic resin, a polycarbonate, a polystyrene, a polymer alloy obtained by blending any such resin with a rubber or an elastomer to make the resin impact resistant, or a modified polyphenylene ether. In the case where an abrupt temperature change, such as heat generation under a high-speed sliding condition, is applied to a molded body molded out of the resin composition, when the thermal expansion rate of the resin composition is large, the degree of expansion and contraction of the composition at the time of its integration with any such other member differs from that of the other member to be responsible for a shape failure. However, no technology for dealing with the problem has heretofore been presented.

Modes for carrying out the present disclosure are described in detail below.

<Construction of Resin Composition>

A resin composition of one embodiment of the present disclosure includes: a polyacetal; conductive carbon black having a dibutyl phthalate oil absorption of 180 ml/100 g or less; graphite; and a polyacetal decomposition inhibitor. The inventors have found that when, in this configuration, the conductive carbon black and the graphite are combined with each other, and the content of the conductive carbon black in the resin composition is set to 16 mass % or more and 20 mass % or less, a resin composition having a low thermal expansion rate, which has high conductivity and provides sufficient dimensional stability against a temperature change at the time of sliding, can be obtained.

However, when the conductive carbon black having the above-mentioned content and the graphite are merely combined with each other, the amounts of the conductive carbon black and the graphite with respect to the polyacetal increase, and hence the total amount of organic functional groups each having an active proton typified by a phenol group on the surfaces of the conductive carbon black and the graphite increases. Accordingly, the decomposition of the polyacetal is accelerated by the active proton. In addition, increases in contents of the conductive carbon black and the graphite are responsible for heat generation due to shear friction at the time of injection molding, and hence the production of formaldehyde due to the thermal decomposition of the polyacetal becomes a problem in practical use.

In view of the foregoing, the resin composition of one embodiment of the present disclosure is characterized by further including at least one polyacetal decomposition inhibitor selected from the group consisting of a compound represented by the formula (1) and a compound represented by the formula (2).

Polyamide and a polymer of acrylamide, an amide compound, an amino-substituted triazine compound and a derivative thereof, urea and a derivative thereof, a hydrazine derivative, an imidazole compound, and an imide compound are each known as the polyacetal decomposition inhibitor.

The mechanism via which the polyacetal decomposition inhibitor selected from the group consisting of the compound represented by the formula (1) and the compound represented by the formula (2) out of those compounds inhibits the decomposition of the polyacetal in a particularly effective manner is unclear. The inventors have assumed that the decomposition of the polyacetal is inhibited because the polyacetal decomposition inhibitor is caused to adsorb to the conductive carbon black or the graphite by an electronic interaction between an aromatic ring that the compound represented by the formula (1) and the compound represented by the formula (2) each have, and the conductive carbon black or the graphite containing many carbon atoms each having a π electron.

A formaldehyde production reaction caused by the decomposition of the polyacetal advances in a chain manner in a repeating structure in which a methylene monomer terminal continues, and hence it is desirable that the chain reaction be immediately terminated by increasing the concentration of the polyacetal decomposition inhibitor near a decomposition site. The organic functional groups each having an active proton typified by a phenol group, which are present on the surfaces of the conductive carbon black and the graphite, may each serve as a decomposition reaction site for the polyacetal, but the presence of the polyacetal decomposition inhibitor near the decomposition reaction site is expected to effectively inhibit the decomposition.

It is also important that the polyacetal decomposition inhibitor have high reactivity with an aldehyde, and the organic functional groups each having an active proton on the conductive carbon black and on the graphite at from about 200° C. to about 250° C. corresponding to the decomposition temperature of the polyacetal. In this point, the structures of the compound represented by the formula (1) and the compound represented by the formula (2) are advantageous. The polyacetal decomposition inhibitor that reacts with the organic functional groups each having an active proton at a temperature lower than the decomposition temperature of the polyacetal is often thermally unstable, and is hence liable to be consumed by a side reaction before its temperature reaches the decomposition temperature of the polyacetal.

The constituent components of the resin composition of the present disclosure are described below.

<Polyacetal>

The polyacetal is a main component in the resin composition of this embodiment, and is incorporated at 60 mass % or more into the resin composition.

Typical examples of the polyacetal to be used in this embodiment may include: a polyacetal homopolymer substantially formed only of an oxymethylene unit, which is obtained by subjecting a formaldehyde monomer or a multimer thereof (e.g., trioxane) to homopolymerization; and a polyacetal copolymer, which is obtained by subjecting a formaldehyde monomer or a multimer thereof (e.g., trioxane) and a glycol, a cyclic ether, or a cyclic formal, such as ethylene oxide, propylene oxide, epichlorohydrin, or 1,3-dioxolane, to copolymerization.

The polyacetal copolymer may be preferably used in terms of chemical stability. In addition, a polyacetal copolymer having a crosslinked structure or a block structure may be used in accordance with the kind of the copolymer, and the structural feature of the polyacetal copolymer is not particularly limited.

Although the terminal structure of the polymer is also not particularly limited, when a hydroxy group of the oxymethylene unit or an aldehyde is present in a terminal portion thereof, it is difficult to put the polymer as it is into practical use because the terminal portion serves as the starting point of the thermal decomposition of the polymer. There is preferably used a polyacetal obtained by subjecting a terminal of the oxymethylene unit to a chemical sealing treatment, or subjecting the unstable terminal portion to a decomposition treatment with any one of, for example, amines and an ammonium compound, to cause a copolymer component except the oxymethylene unit to serve as a terminal.

A commercial polyacetal having added thereto various additives in accordance with its applications may be used in the resin composition of this embodiment. Specific examples thereof include: DURACON (trademark) series manufactured by Polyplastics Co., Ltd.; TENAC (trademark) series and TENAC (trademark)-C series each manufactured by Asahi Kasei Corporation; and Iupital (trademark) series manufactured by Mitsubishi Engineering-Plastics Corporation. In addition, those polyacetals may be mixed with each other.

The melt flow rate (MFR, measured under the conditions of JIS-K7210) of the polyacetal to be used in this embodiment is from 0.5 g/10 min to 100 g/10 min, preferably from 1 g/10 min to 50 g/10 min at 190° C. In addition, the number-average molecular weight of the polyacetal is 150,000 or less, preferably 10,000 or more and 50,000 or less. When those conditions are satisfied, a resin composition satisfying moldability and a desired thermal expansion rate can be obtained.

<Conductive Carbon Black>

The conductive carbon black to be used in the present disclosure is preferably carbon black having a developed chain structure. Carbon black having an average primary particle diameter as an aggregate (aggregate diameter) in the range of from 0.05 μm or more to 1 μm or less is preferably used.

In addition, the content of the conductive carbon black in the resin composition is 16 mass % or more and 20 mass % or less. When the content of the conductive carbon black is 16 mass % or more, sufficient conductivity is exhibited, and desired low thermal expansivity can be obtained. In addition, when the content is 20 mass % or less, the thermal decomposition of the polyacetal can be further inhibited.

In addition, the dibutyl phthalate oil absorption (ASTM D2415-65T) of the conductive carbon black is 180 ml/100 g or less. The conductive carbon black having a dibutyl phthalate oil absorption of 180 ml/100 g or less does not have an excessively large surface area, and hence can further inhibit the thermal decomposition of the polyacetal when added in an amount within the above-mentioned range.

Specific examples of the conductive carbon black include: DENKA BLACK (trademark) (dibutyl phthalate oil absorption of a particulate product: 160 ml/100 g) manufactured by Denki Kagaku Kogyo Kabushiki Kaisha; SEAST (product name) series (dibutyl phthalate oil absorption: 40 ml to 160 ml/100 g) and TOKABLACK (product name) series (dibutyl phthalate oil absorption: 50 ml to 170 ml/100 g) each manufactured by Tokai Carbon Co., Ltd.; and Mitsubishi Carbon Black (product name) series (dibutyl phthalate oil absorption: 40 ml to 180 ml/100 g) manufactured by Mitsubishi Chemical Corporation. In addition, the conductive carbon blacks may be used alone or in combination thereof.

Although a method of producing the conductive carbon black is not particularly limited, acetylene black using an acetylene gas as a raw material is excellent because the amounts of an acidic functional group and adsorbed water on its surface are relatively small, and hence the acetylene black may be suitably used.

<Graphite>

The graphite to be used in the present disclosure may be appropriately selected from an artificial product and a natural product in accordance with purposes. The shape of the graphite is not particularly limited, and any one of, for example, a flaky shape, a lump shape, a spherical shape, and an earthy shape is permitted, but flaky graphite is preferred from the viewpoint of the expression of more satisfactory slidability and more satisfactory conductivity.

The average particle diameter of the graphite to be used in the present disclosure preferably falls within the range of from 0.5 μm to 100 and more preferably falls within the range of from 20 μm to 80 The average particle diameter is preferably 20 μm or more from the viewpoints of high conductivity and dimensional stability at the time of a temperature change, and is preferably 100 μm or less from the viewpoints of handleability and the surface property of a molded article.

Specific examples of the flaky graphite include: CP (product name) series and F # (product name) series each manufactured by Nippon Graphite Industries, Co., Ltd.; and CNP (product name) series and Z (product name) series each manufactured by Ito Graphite Co., Ltd. In addition, two or more kinds of graphite may be used in combination.

In addition, the content of the graphite in the resin composition preferably falls within the range of from 2 mass % or more to 8 mass % or less. When the content of the graphite in the resin composition falls within the range of from 2 mass % or more to 8 mass % or less, the resin composition obtains sufficient conductivity. Further, the total content of the conductive carbon black and the graphite in the resin composition preferably falls within the range of from 18 mass % or more to 24 mass % or less. When the total content of the conductive carbon black and the graphite in the resin composition falls within the range of from 18 mass % or more to 24 mass % or less, a resin composition having a sufficiently low thermal expansion rate and causing no problems in practical use in injection molding applications can be obtained.

<Polyacetal Decomposition Inhibitor>

The polyacetal decomposition inhibitor to be used in the present disclosure is at least one compound selected from the group consisting of the compound represented by the formula (1) and the compound represented by the formula (2):

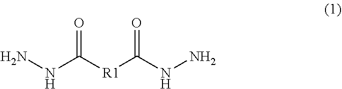

in the formula (1), R1 represents a structure represented by the formula (1-1) or a structure represented by the formula (1-2);

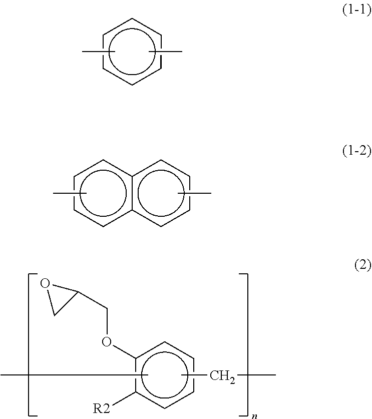

in the formula (2), R2 represents a hydrogen atom or a methyl group, and “n” represents an integer, and when “n” represents 2 or more, R2s may be identical to or different from each other.

When a hydroxy group of the oxymethylene unit or an aldehyde is present in a terminal portion of the polyacetal, or when the main chain of the polymer is cleaved by a radical oxidation reaction at the time of its heating to produce an aldehyde terminal, a chain decomposition reaction into formaldehyde is liable to be advanced by an acid catalyst.

Herein, it is assumed that the compound represented by the formula (1) reacts with any one of aldehydes to seal the terminal and to capture produced formaldehyde, and hence the decomposition of the polyacetal can be inhibited. In addition, it is assumed that epoxy groups in the compound represented by the formula (2) react with acidic phenolic hydroxy groups present on the surfaces of the conductive carbon black and the graphite to reduce the number of decomposition sites on the conductive carbon black and the graphite, thereby exhibiting an inhibiting effect on the decomposition of the polyacetal.

Specific examples of the compound represented by the formula (1) include: phthalic acid hydrazides, such as phthalic acid dihydrazide, isophthalic acid dihydrazide, and terephthalic acid dihydrazide; and dihydrazides of naphthalene dicarboxylic acids. In addition, a hydrazide group can react with a plurality of aldehydes in terms of stoichiometry, and hence an added aromatic dihydrazide compound may react with any other additive or any one of aldehydes to provide a derivative in which part of nitrogen atoms are substituted in the resin composition.

In addition, the compound represented by the formula (1) may be used in combination with any one of: a dihydrazide compound except the compound represented by the formula (1); the compound represented by the formula (2); an epoxy compound except the compound represented by the formula (2); other polyacetal decomposition inhibitors, such as a polyamide, a polyacrylamide, an amide compound, an amino-substituted triazine compound and a derivative thereof, urea and a derivative thereof, a hydrazine derivative, an imidazole compound, and an imide compound; and formic acid scavengers, such as melamine, a hydroxide and a carbonate of an alkali metal, and a hydroxide and a carbonate of an alkaline earth metal.

The content of the compound represented by the formula (1) in the resin composition preferably falls within the range of from 0.1 mass % or more to 1.0 mass % or less, and the content is more preferably 0.5 mass % or less. When the content of the compound represented by the formula (1) is set to 1.0 mass % or less, there can be obtained a resin composition, which has sufficiently small thermal expansivity and is suppressed in occurrence of mold contamination, such as a mold deposit or mold surface contamination, at the time of its injection molding. The compound represented by the formula (1) may be consumed at the time of the production of the resin composition, and hence the content of the compound represented by the formula (1) in the resin composition as used herein is synonymous with the addition amount of the compound represented by the formula (1).

The compound represented by the formula (2) is a condensate of phenol novolac or o-cresol novolac and epichlorohydrin, and its epoxy equivalent preferably falls within the range of from 150 to 250.

In addition, a reaction accelerator is preferably added for accelerating the ring-opening reaction of an epoxy group in the compound represented by the formula (2). Examples of such reaction accelerator include, but are not limited to, an imidazole, a secondary amine, a tertiary amine, a morpholine compound, dicyandiamide, melamine, urea and a derivative thereof, and a phosphorus compound, such as triphenylphosphine. In addition, those compounds may be used alone or in combination thereof.

The content of the compound represented by the formula (2) in the resin composition preferably falls within the range of from 0.5 mass % or more to 2.5 mass % or less in terms of total amount with the content of the reaction accelerator. In addition, the total content of the compound represented by the formula (1) and the compound represented by the formula (2) in the resin composition is preferably 0.3 mass % or more and 2.1 mass % or less. The compound represented by the formula (2) and the reaction accelerator may be consumed at the time of the production of the resin composition, and hence the content of the compound represented by the formula (2) and the reaction accelerator in the resin composition as used herein is synonymous with the addition amount of the compound represented by the formula (2) and the reaction accelerator.

In addition, the compound represented by the formula (2) may be used in combination with any one of: the compound represented by the formula (1); a dihydrazide compound except the compound represented by the formula (1); an epoxy compound except the compound represented by the formula (2); other polyacetal decomposition inhibitors, such as a polyamide, a polyacrylamide, an amide compound, an amino-substituted triazine compound and a derivative thereof, urea and a derivative thereof, a hydrazine derivative, an imidazole compound, and an imide compound; and formic acid scavengers, such as melamine, a hydroxide and a carbonate of an alkali metal, and a hydroxide and a carbonate of an alkaline earth metal.

<Additive>

The resin composition of the present disclosure may be blended with an additive that improves a function of the resin composition except the polyacetal, the conductive carbon black, the graphite, and the polyacetal decomposition inhibitor as required. Examples of the additive include: flame retardants; lubricants and release agents, such as waxes, various fatty acids, fatty acid amides, fatty acid esters, and fatty acid metal salts; slidability-improving agents, such as various antistatic agents, fatty acid esters, polyolefins, and polysiloxanes; and impact resistance-improving agents, such as a polyurethane elastomer, a polyester elastomer, and a polystyrene elastomer. In addition, the examples also include, as various additives for improving long-term stability: UV absorbers, such as a benzotriazole-based compound, a benzophenone-based compound, and a phenyl salicylate compound; hindered amine-based light stabilizers; and hindered phenol-based antioxidants.

In particular, the fatty acid esters may each be suitably used because the esters are effective in improving slidability and alleviating a kneading torque at the time of the production of the resin composition. Specifically, an ester of a monovalent fatty acid and a monovalent aliphatic alcohol is preferred. A monovalent fatty acid that is naturally derived and easily available is, for example, myristic acid, stearic acid, montanic acid, oleic acid, linoleic acid, or linolenic acid, and an ester obtained from any such acid and an aliphatic alcohol may be suitably used. In particular, each of cetyl myristate and stearyl stearate is more preferred in terms of balance among characteristics such as slidability, a thermal deformation temperature, and a torque reduction amount at the time of kneading when used as an additive. The content of any one of the fatty acid esters in the resin composition is preferably 10 mass % or less for the purpose of securing a balance among those characteristics and low thermal expansivity.

In addition, an inorganic component, such as a metal oxide, a metal hydroxide, a carbonate, a sulfate, a silicate compound, a glass-based filler, a silicic acid compound, metal powder or a metal fiber, a carbon fiber, or a carbon nanotube, may be incorporated for the purpose of improving a function of the resin composition, such as a low thermal expansion rate or rigidity, to such an extent that the conductive performance of the present disclosure is not impaired. Examples of the metal oxide include alumina, zinc oxide, titanium oxide, cerium oxide, calcium oxide, magnesium oxide, iron oxide, tin oxide, and antimony oxide. Examples of the metal hydroxide include calcium hydroxide, magnesium hydroxide, and aluminum hydroxide. Examples of the carbonate include basic magnesium carbonate, calcium carbonate, magnesium carbonate, zinc carbonate, barium carbonate, dawsonite, and hydrotalcite. Examples of the sulfate include calcium sulfate, barium sulfate, magnesium sulfate, and a gypsum fiber. Examples of the silicate compound include calcium silicate (e.g., wollastonite or xonotlite), talc, clay, mica, montmorillonite, bentonite, activated earth, sepiolite, imogolite, sericite, kaolin, vermiculite, and smectite. Examples of the glass-based filler include a glass fiber, a milled glass fiber, glass beads, glass flakes, and glass balloons. Examples of the silicic acid compound include silica (e.g., white carbon) and silica sand. As a main element for forming the metal powder or the metal fiber, there are given, for example, iron, aluminum, titanium, and copper, and a composite of any such element and another element may also be adopted.

The surfaces of those inorganic components may be treated with, for example, various surface treatment agents, such as a silane coupling agent, a titan coupling agent, an organic fatty acid, an alcohol, and an amine, a wax, and a silicone resin.

<With Regard to Constituent Components>

The construction of the resin composition of the present disclosure may be known by combining a known separation technology and a known analysis technology.

Although a method and a procedure for the separation and the analysis are not particularly limited, for example, the following may be performed: a solution is obtained by extracting organic components form a thermoplastic resin composition, and its components are separated by, for example, various kinds of chromatography, and are then analyzed.

To extract the organic components from the resin composition, the resin composition only needs to be dissolved in a solvent in which the organic components are soluble. A time period required for the extraction can be shortened by finely crushing the thermoplastic resin composition in advance or by stirring the solvent under heating.

Although the solvent to be used may be arbitrarily selected in accordance with the properties of the organic components for forming the resin composition, a solvent such as hexafluoropropanol is suitably used.

Herein, the content of an inorganic component in the resin composition may be known by drying and weighing the residue remaining after the separation of the organic components. In addition to the foregoing, the following method is available as a method of knowing the content of the inorganic component of the resin composition: the temperature of the resin composition is increased from normal temperature to a temperature equal to or more than its decomposition temperature by thermogravimetric analysis (TGA) or the like under an inert gas atmosphere, such as nitrogen, and an ash content is determined from the residual weight.

From the solution obtained by extracting the organic components from the resin composition, the components may be separated by methods such as various kinds of chromatography. Low-molecular weight additives may be separated by gas chromatography (GC) or high performance liquid phase column chromatography (HPLC), and a high-molecular weight polymer may be separated by gel permeation chromatography (GPC) or the like. In particular, when the solution contains a crosslinked polymer or gel having a large molecular weight, or when a micelle is formed in the solution, centrifugal separation or separation with a semipermeable membrane may be selected.

The separated organic components may be analyzed by a known analysis approach, such as nuclear magnetic resonance (NMR) spectrum measurement, infrared absorption (IR) spectrum measurement, Raman spectrum measurement, mass spectrum measurement, or elemental analysis.

<Method of Producing Resin Composition>

A method of producing the resin composition is not limited to a specific method, and a mixing method that has been generally adopted for a thermoplastic resin may be used. For example, the composition may be produced by mixing and kneading the respective components with a mixing machine, such as a tumbler, a V-type blender, a Banbury mixer, a kneading roll, a kneader, a single-screw extruder, or a multi-screw extruder having two or more screws. In particular, melting and kneading with a twin-screw extruder are excellent in productivity.

In the production of the resin composition, a plurality of components out of the polyacetal, the conductive carbon black, the graphite, the polyacetal decomposition inhibitor, and the additive to be used as required may be preliminarily mixed or preliminarily kneaded in advance, or all the components may be simultaneously mixed or kneaded. In particular, in the production thereof with an extruder, the following kneading may be performed: an individual feeder is arranged for each component, and sequential addition is performed in an extrusion process.

The compound represented by the formula (1) may be consumed by a reaction with the compound represented by the formula (2) or any other component. Accordingly, when the compound represented by the formula (1) and the compound represented by the formula (2) are used in combination as decomposition inhibitors, the compound represented by the formula (1) is preferably added after the compound represented by the formula (2) has been added, and then the reaction accelerator has been added to treat an unreacted epoxy residue.

When the additive is preliminarily mixed with one or a plurality of the polyacetal, the conductive carbon black, the graphite, and the polyacetal decomposition inhibitor, the mixture only needs to be treated by a dry method or a wet method. The dry method includes stirring the components with a stirring machine, such as a Henschel mixer or a ball mill. The wet method includes: adding the polyacetal to a solvent; stirring the mixture; and drying and removing the solvent after the mixing.

In the production of the resin composition by the melting and kneading of the components, a kneading temperature, a kneading time, and a feeding rate may be arbitrarily set in accordance with the kind and performance of a kneading apparatus, and the properties of the components, that is, the polyacetal, the conductive carbon black, the graphite, and the polyacetal decomposition inhibitor, and the additive to be used as required. The kneading temperature is typically from 150° C. to 250° C., preferably from 160° C. to 230° C., more preferably from 170° C. to 210° C. When the temperature is excessively low, the dispersion of the conductive carbon black and the graphite is inhibited, and when the temperature is excessively high, the thermal decomposition of the polyacetal becomes a problem, and hence formaldehyde may be produced or reductions in various physical properties may occur.

<Method of Producing Resin Molded Body>

The resin composition according to the embodiment of the present disclosure may be easily molded into a resin molded body by a molding method that has been generally used, such as extrusion molding, injection molding, or compression molding. Blow molding, vacuum molding, two-color molding, insert molding, or the like may also be applied as a molding method. The content of the polyacetal in the resin molded body thus obtained is 60 mass % or more, and the content of the conductive carbon black therein is 16 mass % or more and 20 mass % or less. Accordingly, the resin molded body has an average linear expansion coefficient of 40 ppm/° C. or more and less than 100 ppm/° C. at 20° C. or more and 60° C. or less.

In addition, when the resin molded body obtained in the foregoing is adopted as a first resin molded body, and an amorphous plastic, such as an acrylic resin, a polycarbonate, a polystyrene, a polymer alloy obtained by blending any such resin with a rubber or an elastomer to make the resin impact resistant, or a modified polyphenylene ether, is adopted as a second resin molded body, the linear expansion coefficient of the first resin molded body and the linear expansion coefficient of the second resin molded body can be made comparable to each other. Accordingly, the first resin molded body may be particularly suitably used in joining or integral molding with the amorphous plastic to provide a resin member. The resin molded body and the resin member are applied as parts for OA equipment, and other electrical and electronic equipment, or conductive functional parts for electrical and electronic equipment. The resin molded body and the resin member may also be applied to, for example, structural members for an automobile, an aircraft, and the like, building members, and food containers. That is, the resin composition according to the embodiment of the present disclosure may be applied to various production methods each including molding the resin composition with a mold to produce a molded article. Specifically, each of the resin molded body and the resin member is suitably used in, for example, an electrical contact member in electrical and electronic equipment, or a photosensitive drum flange, a process cartridge part, or a bearing member in an image-forming apparatus.

### EXAMPLES

Raw materials commonly used in Examples (including Comparative Examples) are as described below.

(Polyacetal)

<A-1> DURACON (trademark) M90CA (product name) manufactured by Polyplastics Co., Ltd.
<A-2> TENAC (trademark)-C HC750 (product name) manufactured by Asahi Kasei Corporation

(Conductive Carbon Black)

<B-1> DENKA BLACK (trademark) granule manufactured by Denka Company Limited (dibutyl phthalate oil absorption: 160 ml/100 g)
<B-2> PRINTEX (trademark) XE2-B (product name) manufactured by Orion Engineered Carbons (dibutyl phthalate oil absorption: 420 ml/100 g)

(Graphite)

<C-1> Flake Graphite Z-25 (product name) manufactured by Ito Graphite Co., Ltd., average particle diameter: 25 μm

(Polyacetal Decomposition Inhibitor)

<D-1> Isophthalic acid dihydrazide K-IDH (product name) manufactured by Japan Finechem Company, Inc.
<D-2> Adipic acid dihydrazide ADH (product name) manufactured by Japan Finechem Company, Inc.
<D-3> Succinic acid dihydrazide SUDH (product name) manufactured by Japan Finechem Company, Inc.
<D-4> Sebacic acid dihydrazide SDH (product name) manufactured by Japan Finechem Company, Inc.
<D-5> Dodecanedioic acid dihydrazide N-12 (product name) manufactured by Japan Finechem Company, Inc.
<D-6> Cresol novolac-type epoxy resin EPICLON-695 (product name) manufactured by DIC Corporation

(Reaction Accelerator)

<E-1> Triphenylphosphine manufactured by Kishida Chemical Co., Ltd. (used as an epoxy curing accelerator)
<E-2> Dicyandiamide manufactured by Kishida Chemical Co., Ltd. (used as an epoxy curing agent)

(Additive)

<F-1> SPERMACETI (product name) manufactured by NOF Corporation (main component: cetyl myristate)
<F-2> UBE Polyethylene L719 (product name) manufactured by Ube-maruzen Polyethylene

### Example 1

The polyacetal was dried at a temperature of 90° C. for 3 hours in advance. After that, the conductive carbon black, the graphite, and the polyacetal decomposition inhibitor (D-1) were added so that the mass % of each component in a resin composition became a blending amount shown in Table 1. Thus, a blend of the raw materials was produced. The blend was melted and kneaded with a twin-screw extruder PCM30 (product name) manufactured by Ikegai Corp. under the condition of a cylinder temperature of 200° C. to produce a strand. Thus, a resin composition of Example 1 was obtained. The strand was cut with a pelletizer to provide a pellet of the resin composition of Example 1.

### Comparative Examples 1 to 4

Resin compositions of Comparative Examples 1 to 4 and pellets thereof were each obtained by the same method as that of Example 1 except that the polyacetal decomposition inhibitor (D-1) was changed to any one of the polyacetal decomposition inhibitors (D-2) to (D-5).

TABLE 1

| | Polyacetal | | Carbon black | | Graphite | | Decomposition inhibitor | |
|---|---|---|---|---|---|---|---|---|
| | Kind | Mass % | Kind | Mass % | Kind | Mass % | Kind | Mass % |
| Example 1 | A-1 | 77.7 | B-1 | 18 | C-1 | 4 | D-1 | 0.3 |
| Comparative | | | | | | | D-2 | |
| Example 1 | | | | | | | | |
| Comparative | | | | | | | D-3 | |
| Example 2 | | | | | | | | |
| Comparative | | | | | | | D-4 | |
| Example 3 | | | | | | | | |
| Comparative | | | | | | | D-5 | |
| Example 4 | | | | | | | | |

(Evaluation of Volume Resistivity of Resin Composition)

The resin composition of Example 1 was portioned out under the state of the strand before the cutting, and its diameter was measured with calipers. The resistance value of a range having a length of 5 cm was measured with HANDY MILLI-OHM TESTER SK-3800 (product name) manufactured by Kaise Corporation, and the volume resistivity of the resin composition was calculated. The result is shown in Table 2.

(Evaluation of Thermal Stability of Resin Composition)

When the polyacetal in the resin composition decomposes to produce a formaldehyde gas, the mass loss of the resin composition can be observed. About 10 mg of a sample produced by cutting the pellet of the resin composition with a cutter was held in a stream of nitrogen at 225° C. for 1 hour with THERMOGRAVIMETRIC ANALYZER (TGA) Q500 manufactured by TA Instruments, and its mass loss ratio was measured. The result is shown in Table 2.

(Production of Molded Test Specimen)

The pellet of the resin composition of Example 1 was subjected to injection molding with an injection molding machine SE-180D (product name) manufactured by Sumitomo Heavy Industries, Ltd. at a cylinder temperature of 200° C. and a mold temperature of 60° C. to produce a test specimen corresponding to a bar test specimen type B1 (measuring 80 mm long by 10 mm wide by 4 mm thick) specified in JIS K 7152-1.

(Evaluation of Linear Expansion Coefficient)

The produced test specimen was left to stand at 80° C. for 10 minutes so that its molding stress was removed, followed by the measurement of its linear expansion coefficient with THERMAL ANALYZER (TMA) Q400 (product name) manufactured by TA Instruments. In the measurement of the linear expansion coefficient, a temperature increase-decrease process including an interval ranging from 20° C. to 60° C. was performed at a rate of 5° C./min three times, and the average of measured values obtained in the three cycles was calculated. The result is shown in Table 2.

The resin compositions of Comparative Examples 1 to 4 were subjected to the above-mentioned evaluations as in the resin composition of Example 1. The results of the volume resistivity evaluations of the resin compositions of Comparative Examples 1 to 4, the results of the linear expansion coefficient evaluations thereof, and the results of the mass loss ratios thereof serving as their thermal stability evaluations are shown in Table 2.

TABLE 2

| | | Hydrazide | | | |
|---|---|---|---|---|---|
| | | functional group | | Linear | |
| | Structure between two | concentration in | Volume | expansion | Mass loss |
| | hydrazide groups in | composition | resistivity | coefficient | ratio |
| | decomposition inhibitor | μmol/g | Ω · cm | ppm/° C. | % |
| Example 1 | Aromatic group (having | 15.4 | 7 | 91 | 0.84 |
| | 6 carbon atoms) | | | | |
| Comparative | Aliphatic group (having | 20.5 | 8 | 92 | 1.35 |
| Example 1 | 2 carbon atoms) | | | | |
| Comparative | Aliphatic group (having | 17.2 | 8 | 92 | 1.41 |
| Example 2 | 4 carbon atoms) | | | | |
| Comparative | Aliphatic group (having | 13.0 | 7 | 92 | 1.36 |
| Example 3 | 8 carbon atoms) | | | | |
| Comparative | Aliphatic group (having | 11.6 | 7 | 92 | 1.49 |
| Example 4 | 10 carbon atoms) | | | | |

As can be seen from Table 2, although no significant differences are found between the volume resistivities of the compositions and between the linear expansion coefficients of the molded bodies depending on the kinds of the polyacetal decomposition inhibitors, the mass loss is significantly suppressed by the addition of the compound represented by the formula (1), and hence the resin composition of Example 1 is excellent in thermal stability.

In Example 1 and Comparative Examples 1 to 4, the contents of the polyacetal decomposition inhibitors in the resin compositions are equal to each other, and hence the hydrazide functional group concentrations in the resin compositions of Comparative Examples 1 and 2 are higher than the hydrazide functional group concentration in the resin composition of Example 1 because of the molecular weights of their polyacetal decomposition inhibitors as shown in Table 2. Interestingly, however, no correlation was found between the hydrazide functional group concentration in each of the resin compositions and the thermal stability of the resin composition. In addition, the reaction of a hydrazide group with an aldehyde is nucleophilic, and hence the reactivity of an electron-donating aliphatic hydrazide was expected to be higher than the reactivity of an aromatic hydrazide, albeit slightly. However, contrary to the expectation, the thermal stability of the resin composition of Example 1 including the compound represented by the formula (1) that was an aromatic hydrazide was excellent.

(Production of Resin Compositions)

Next, resin compositions of Examples 2 to 10 and Comparative Examples 5 to 8 were each produced under the same conditions as those of Example 1 except that the kinds and blending amounts of the polyacetal, the conductive carbon black, the graphite, the polyacetal decomposition inhibitor, the reaction accelerator, and the additive were changed as shown in Table 3.

TABLE 3

| | | | | | | | Decomposition inhibitor | | | | Reaction | | | |
|---|---|---|---|---|---|---|---|---|---|---|---|---|---|---|
| | | | | | | | Compound represented | | Compound represented | | accelerator | | Additive | |
| | Polyacetal | | Carbon black | | Graphite | | by formula (1) | | by formula (2) | | E-1 | E-2 | F-1 | F-2 |
| | Kind | Mass % | Kind | Mass % | Kind | Mass % | Kind | Mass % | Kind | Mass % | Mass % | Mass % | Mass % | Mass % |
| Example 2 | A-1 | 76.7 | B-1 | 16 | C-1 | 4 | D-1 | 0.3 | | | | | 3 | |
| Example 3 | | 74.7 | | 18 | | | D-1 | 0.3 | | | | | | |
| Example 4 | | 74.1 | | 18 | | | | | D-6 | 0.6 | 0.3 | | | |
| Example 5 | | 73.2 | | 18 | | | | | D-6 | 1.2 | 0.6 | | | |
| Example 6 | | 73.14 | | 18 | | | | | D-6 | 1.2 | 0.6 | 0.06 | | |
| Example 7 | | 72.9 | | 18 | | | D-1 | 0.3 | D-6 | 1.2 | 0.6 | | | |
| Example 8 | | 72.7 | | 20 | | | D-1 | 0.3 | | | | | | |
| Example 9 | A-2 | 68.1 | | 18 | | | D-1 | 0.3 | | | | | | 6.6 |
| Example 10 | | 66.54 | | 18 | | | | | D-6 | 1.2 | 0.6 | 0.06 | | 6.6 |
| Comparative | A-1 | 79.0 | | 18 | None | | None | | | | None | | | |
| Example 5 | | | | | | | | | | | | | | |
| Comparative | | 83.4 | B-2 | 7.8 | C-1 | 4 | | | D-6 | 1.2 | 0.6 | | | |
| Example 6 | | | | | | | | | | | | | | |
| Comparative | | 78.7 | B-1 | 14 | | | D-1 | 0.3 | | | | | | |
| Example 7 | | | | | | | | | | | | | | |
| Comparative | | 70.7 | | 22 | | | D-1 | 0.3 | | | | | | |
| Example 8 | | | | | | | | | | | | | | |

The resin compositions produced in Examples 2 to 10 and Comparative Examples 5 to 8 were subjected to volume resistivity evaluations, linear expansion coefficient evaluations, and thermal stability evaluations in the same manner as in Example 1, and the results were summarized in Table 4. With regard to the thermal stability evaluations, although the degree of the mass loss of each of the resin compositions changes in accordance with the presence or absence of any other component, the criterion of a mass loss causing no problem in molding after the holding of the composition in a stream of nitrogen at 225° C. for 1 hour was set to a mass loss of 1.0 mass %, and a resin composition showing a mass loss of less than 1.0 mass % was evaluated as being satisfactory, while a resin composition that was observed to show a mass loss of 1.0 mass % or more was evaluated as being unsatisfactory.

TABLE 4

| | Volume | Linear expansion | |
|---|---|---|---|
| | resistivity | coefficient | Thermal |
| | Ω · cm | ppm/° C. | stability |
| Example 2 | 7 | 95 | Satisfactory |
| Example 3 | 7 | 94 | Satisfactory |
| Example 4 | 8 | 95 | Satisfactory |
| Example 5 | 9 | 95 | Satisfactory |
| Example 6 | 9 | 92 | Satisfactory |
| Example 7 | 8 | 94 | Satisfactory |
| Example 8 | 6 | 91 | Satisfactory |
| Example 9 | 7 | 95 | Satisfactory |
| Example 10 | 7 | 94 | Satisfactory |
| Comparative Example 5 | >100 | 101 | Unsatisfactory |
| Comparative Example 6 | 7 | 105 | Satisfactory |
| Comparative Example 7 | >100 | 102 | Satisfactory |
| Comparative Example 8 | 6 | Molding failure | Unsatisfactory |

The results of Examples 3 to 7 and Comparative Example 5 showed that the exhibition of high conductivity required the incorporation of the graphite into a resin composition. In addition, the results of Examples 2 to 10 and Comparative Examples 6 to 8 showed that when a resin composition included conductive carbon black having a dibutyl phthalate oil absorption of 180 ml/100 g or less, and the content of the conductive carbon black in the resin composition fell within the range of from 16 mass % or more to 20 mass % or less, a resin composition achieving both of high conductivity and a low thermal expansion rate, and causing no problems in practical use in injection molding applications, and a molded body molded out of the composition were obtained.

Each of the resin molded body and resin member of the present disclosure is excellent in conductivity and dimensional stability, and is hence suitably used in, for example, an electrical contact member in electrical and electronic equipment, or a photosensitive drum flange, a process cartridge part, or a bearing member in an image-forming apparatus.

According to the present disclosure, there can be obtained the resin composition having a low thermal expansion rate and causing no problems in practical use in injection molding applications, which has high conductivity and provides sufficient dimensional stability against a temperature change at the time of sliding, and the molded body molded out of the composition.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-199319, filed Oct. 31, 2019, which is hereby incorporated by reference herein in its entirety.

What is claimed is:

1. A resin composition comprising:
a polyacetal;
conductive carbon black;
graphite; and
at least one selected from the group consisting of a compound represented by the formula (1) and a compound represented by the formula (2),
wherein the conductive carbon black has a dibutyl phthalate oil absorption of 180 ml/100 g or less,
wherein a content of the polyacetal in the resin composition is 60 mass % or more, and
wherein a content of the conductive carbon black in the resin composition is 16 mass % or more and 20 mass % or less: 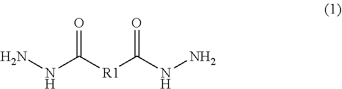
in the formula (1), R1 represents a structure represented by the formula (1-1) or a structure represented by the formula (1-2); 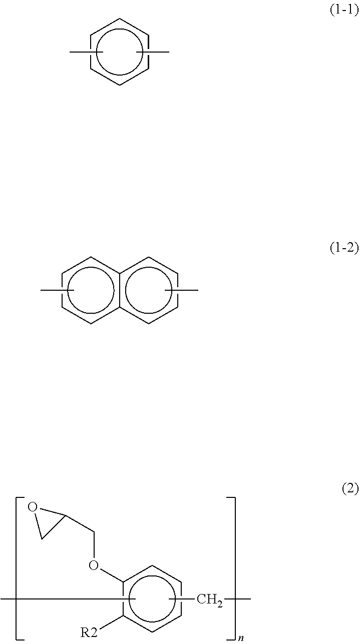
in the formula (2), R2 represents a hydrogen atom or a methyl group, and “n” represents an integer, and when “n” represents 2 or more, R2s may be identical to or different from each other.

2. The resin composition according to claim 1, wherein a total content of the compound represented by the formula (1) and the compound represented by the formula (2) in the resin composition is 0.3 mass % or more and 2.1 mass % or less.

3. The resin composition according to claim 2, wherein a content of the compound represented by the formula (1) in the resin composition is 0.1 mass % or more and 1.0 mass % or less.

4. The resin composition according to claim 1, wherein a total content of the conductive carbon black and the graphite in the resin composition is 18 mass % or more and 24 mass % or less.

5. The resin composition according to claim 4, wherein a content of the graphite in the resin composition is 2 mass % or more and 8 mass % or less.

6. A resin molded body comprising:
a polyacetal;
conductive carbon black;
graphite; and
at least one selected from the group consisting of a compound represented by the formula (1) and a compound represented by the formula (2),
wherein the conductive carbon black has a dibutyl phthalate oil absorption of 180 ml/100 g or less,
wherein a content of the polyacetal in the resin molded body is 60 mass % or more, and
wherein a content of the conductive carbon black in the resin molded body is 16 mass % or more and 20 mass % or less: 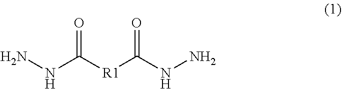
in the formula (1), R1 represents a structure represented by the formula (1-1) or a structure represented by the formula (1-2); 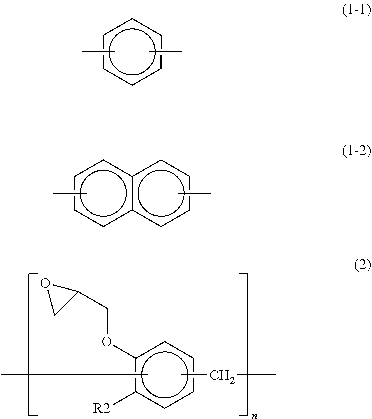
in the formula (2), R2 represents a hydrogen atom or a methyl group, and “n” represents an integer, and when “n” represents 2 or more, R2s may be identical to or different from each other.

7. The resin molded body according to claim 6, wherein the resin molded body has an average linear expansion coefficient of 40 ppm/° C. or more and less than 100 ppm/° C. at 20° C. or more and 60° C. or less.

8. A resin member comprising:
a first resin molded body; and
a second resin molded body,
the first resin molded body and the second resin molded body being joined to each other,
wherein the first resin molded body is the resin molded body of claim 6, and
wherein the second resin molded body includes at least one selected from the group consisting of an acrylic resin, a polycarbonate, a polystyrene, a polymer alloy obtained by blending one of the polycarbonate and the polystyrene with one of a rubber and an elastomer, and a modified polyphenylene ether.

9. An article comprising a resin molded body,
the resin molded body comprising:
a polyacetal;
conductive carbon black;
graphite; and
at least one selected from the group consisting of a compound represented by the formula (1) and a compound represented by the formula (2),
wherein the conductive carbon black has a dibutyl phthalate oil absorption of 180 ml/100 g or less,
wherein a content of the polyacetal in the resin molded body is 60 mass % or more, and
wherein a content of the conductive carbon black in the resin molded body is 16 mass % or more and 20 mass % or less: 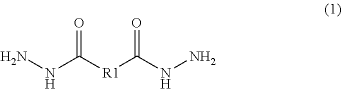
in the formula (1), R1 represents a structure represented by the formula (1-1) or a structure represented by the formula (1-2); 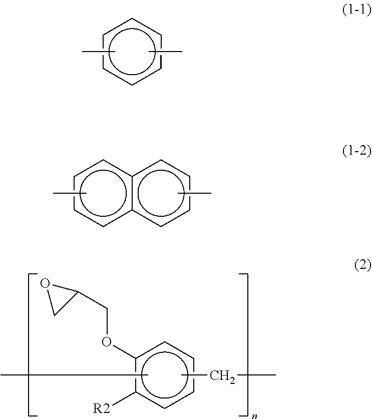
in the formula (2), R2 represents a hydrogen atom or a methyl group, and “n” represents an integer, and when “n” represents 2 or more, R2s may be identical to or different from each other.

10. The article according to claim 9, wherein the article is at least one selected from the group consisting of an electrical contact member, a photosensitive drum flange, a process cartridge part, and a bearing member.
